(19) United States
(12) Patent Application Publication
(10) Pub. No.: US 2007/0059515 A1
(43) Pub. Date: Mar. 15, 2007

(54) Construction of gliding board

(76) Inventor: Kwong Kee Cheung, Kowloon (HK)

Correspondence Address: JACOBSON HOLMAN PLLC, 400 SEVENTH STREET N.W., SUITE 600, WASHINGTON, DC, 20004, US

(21) Appl. No.: 11/599,482

(22) Filed: Nov. 15, 2006

Related U.S. Application Data
(63) Continuation-in-part of application No. 10/853,103, filed on May 26, 2004, now Pat. No. 7,063,769.
(63) Continuation-in-part of application No. 11/406,295, filed on Apr. 19, 2006.

(51) Int. Cl. B32B 3/26

(52) U.S. Cl. 428/314.8; 428/304.4

(57) ABSTRACT

A gliding board, for sliding on water, snow and land, is constructed from polyethylene and polypropylene foams, in three-ply or more layers of constant density or different densities as a multi-layer reinforced core. The use of polypropylene foam layers encompassing the core together with the application of thermoplastic binding Layer in between each layer enhances greater cohesive characteristics to join foam materials with different properties.

### TECHNICAL FIELD

The present invention relates to foam sports boards for recreational use having a laminated gliding board with a sandwich construction, based upon a low density polyethylene foam core and sandwich composite polypropylene foam skins. The present invention is a light-weight board that uses more durable and flexible materials and is able to create higher performance, shapes and designs for recreational use.

### BACKGROUND OF THE INVENTION

In the current market, the core and deck of most of the low-cost gliding boards are commonly made of polyethylene foam, a type of foam which has a moderate solidity. The reason being that the price of polyethylene foam is stable and reasonable, the solidity of the polyethylene foam is moderate (polyethylene foam is harder than ethylene vinyl acetate foam but softer than expanded polystyrene foam), and the processing of the material is much easier. Low density light weight polyethylene foam is comparatively reasonable but also carries an average solidity. Polypropylene foam, a different type of foam, favorably carries a greater solidity and is not detrimental by greatly increasing weight. Hence, when comparing two gliding boards which one of which is made of high stiffness foam and the other is made of low stiffness foam, the one made of high stiffness foam is more advantageous than the one made of low stiffness foam no matter the velocity or direction control of the gliding board.

In a technical aspect, direct rigidity enhancement to the core of a polyethylene foam gliding board is often complicated and difficult to accomplish. Although polyethylene is the preferred foam for use in manufacturing sports boards, there exist many deficiencies that occur with this type of material. Polyethylene foam carries a tendency to lose shape and solidity after long term use and exposure to the sun. Therefore, when attempting to correct these features, augmentations should focus on the surrounding areas (the deck and bottom layer) of the foam, for example adding further layers to protect this foam. Polyethylene foam also has a considerably greater mass. Polypropylene foam, a different type of foam with comparatively similar features is less commonly used for manufacturing sports boards as it is more costly. However, this type of foam carries a one hundred percent greater solidity and a thirty to fifty percent lighter weight than polyethylene foam. In order to compensate for the cost aspect of using this type of foam, polypropylene foam will be used in a lesser amount, and placed as a protective layer surrounding the polyethylene foam. Conclusively, polypropylene foam material is exceptionally suitable for the surrounding layer of polyethylene foam core as it will appreciably strengthen the solidity of a common gliding board.

However, with bonding two foam layers of different characteristics, specific work processes are needed. It is known that heat may directly be used to bond different layers together, however, the thermal laminating process usually requires complex procedures and carries risks such as undesirable shrinking of the layers. A more favorable process would involve a thermoplastic binding layer of adhesive resin, for example metallocene catalyst, which is pre-heated and applied to the surface of one of the foam layers. After the lamination, the quality of the entire foam layer is significantly improved: solidity increasing by ten per cent to thirty per cent and weight reducing five per cent to twenty per cent.

### SUMMARY OF THE INVENTION

The primary objective of the present invention is to provide an improved gliding board made of compound foam materials in order to resolve the limitations of a loss of solidity and a decrease of function. This present invention is a gliding board with a greater firmness and cohesion of structure without an increase in weight.

In a second aspect, the present invention fully utilizes the characteristics of different foam material in the arrangement and the construction of a gliding board.

In a third aspect, the present invention allows a variety of foam materials in the composition of the core, deck, stronger layers, concord layer and bottom solid sheet of a gliding board. The use of thermoplastic binding layers creates a durable and secure organization of core layers and provides a better performance of gliding boards.

### BRIEF DESCRIPTION OF THE DRAWINGS

FIG. 1 is a cross-sectional view of new invention gliding board structure with deck and concord layer.

FIG. 2 is a cross-sectional view of new invention gliding board structure with plastic polymer graphic film underneath board core.

FIG. 3 is a cross-sectional view of a second embodiment of new invention gliding board structure.

FIG. 4(a) is a partial schematic view of the new methodology of bonding of plastic polymer graphic film to deck or outer core of the present invention.

FIG. 4(b) is a partial schematic view of the new methodology of viscose of a polypropylene/polyethylene/ethylene vinyl acetate board core of the present invention.

FIG. 4(c) is a partial schematic view of the method of manufacturing of gliding board of the present invention.

### DETAILED DESCRIPTION OF THE PREFERRED EMBODIMENTS

The invention is described in connection with certain preferred embodiments, i.e. using a pair of polypropylene foam layers to sandwich the core in order to enhance the rigidity, and using compound thermoplastic substance to laminate foam Layers of different category. It is to be understood that the present invention is not to be limited to any particular construction of the reinforced core of the gliding board, or to the use of any particular kind of compound thermoplastic substance in bonding the reinforced core of the gliding board. The compound thermoplastic substance may be varied in accordance with the category, grade, property and density of the foam materials composing the reinforced core, stronger layers and concord layer of the gliding board. In addition, the present invention is not limited to any particular construction of the gliding boards shown in the figures and may be of any configuration as is known in the art. Throughout the descriptions, the arrangement of the layers are described using terms “top” and “bottom” and “upper” and “lower”. In order to further clarify the location of the layers, the terms “top” and “upper” as well as “bottom” and “lower” describe the locations as they are illustrated in the drawings. The terms “outer” and “inner” are also used to describe the location of the layers, “outer” meaning further from the core, and “inner” signifying

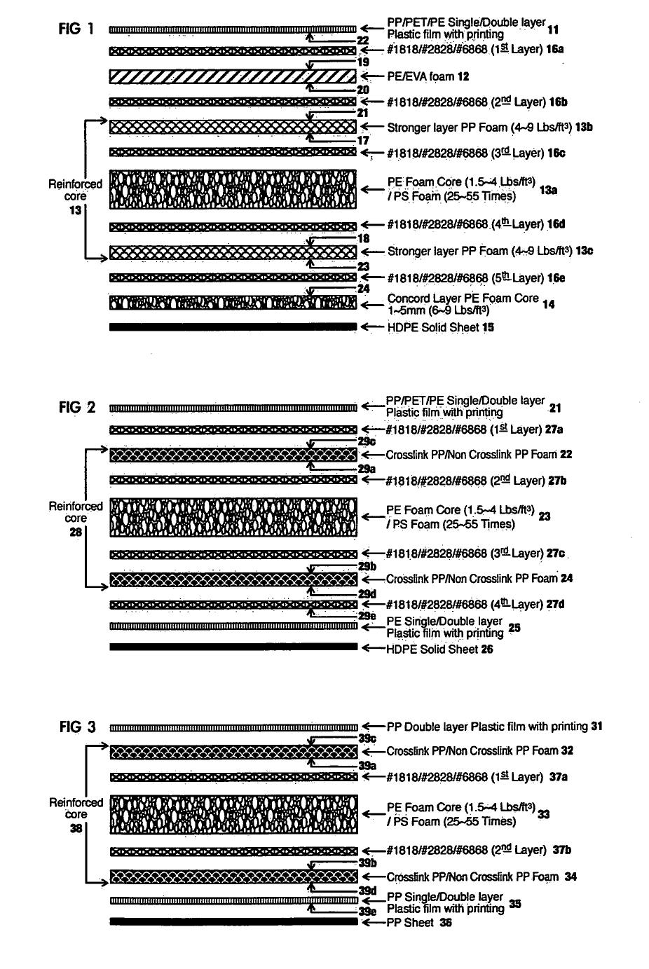

FIG. 1 shows a cross-sectional view of the structure of the present invention with which seven layers of different foam materials constitute the gliding board. This gliding board has a core represented by 13a, laminated by a pair of stronger layers 13b, 13c with two thermoplastic layers 16c, 16d as bonding agents forming a reinforced core 13, a deck foam 12 laminated on top of reinforced core 13, a concord layer 14 laminated to the inner surface reinforced core 13, a plastic graphic film 11 laminated on top of the deck foam 12 with a thermoplastic binding layer 16a as bonding agent, and a slick (bottom solid sheet) 15.

The core 13a is closed-cell low density polyethylene or polystyrene foam, having a thickness of 20 to 80 mm and a density of 1.5 to 4 lbs/ft³. Stronger layers, marked by 13b and 13c, are closed-cell high density polypropylene foam, each having a thickness of 1.5 to 5 mm and has a density of 4 to 9 lbs/ft³. The stronger layers serve as the covering of the core 13a functioning to enhance the rigidity of the core of the gliding board. In order to laminate the core 13a of polyethylene foam and a pair of the stronger layers of polypropylene foam 13b and 13c, a pair of thermoplastic binding Layers 16b, 16c are applied, in manner of extrude coating, to the upper surface 21 and lower surface 17 of the stronger layer 13b. Similarly, another pair of thermoplastic binding layers 16d, 16e is applied to the upper surface 18 and lower surface 23 of the strong layer 13c. Thereafter, the said pair of stronger layers 13b and 13c are laminated to the core 13a in such a manner that the core 13a is the center of the layers, and sandwiched by layer 13b and layer 13c, by heat lamination and to a form a reinforced core 13. The functions of the thermoplastic substance not only to fill in the air cells on the surface of polypropylene board core and to enhance the stiff of the board, but also the cohesive agent to get two different foam layers firmly united.

Furthermore, thermoplastic binding layers 16c and 16d also function as the cohesive agent with the core 13a and the layers 13b and 13c to achieve a secure and durable structure. Thermoplastic binding layers 16b, 16c, 16d and 16e are selected from a compound thermoplastic substance #1818, which is comprised of low density polyethylene, ethylene vinyl acetate and tackifying resin; substance #2828, which is comprised of metallocene-catalyzed resin and polyethylene; and substance #6868, which is comprised of anhydride-modified ethylene vinyl acetate polymers. Each thermoplastic binding layer has a thickness of approximately 0.02 to 0.10 mm.

Deck 12 may be closed-cell high density ethylene vinyl acetate foam or high density polyethylene foam which has a thickness ranging from 1 to 5 mm and a density ranging from 4 to 10 lbs/ft³. If deck 12 is made of ethylene vinyl acetate, it has a hardness ranging from 35 to 65 degrees. Being that deck 12, stronger layer 13b and the top plastic film 11 are different foam materials, and a thermoplastic binding layer 16b has already been coated onto the outer surface 21 of the stronger layer 13b, another thermoplastic binding layer 16a must be applied to the outer surface 19 of the deck 12 as they serve as cohesive agents. By heat lamination, deck 12 is jointed to top plastic graphic film in such a manner that thermoplastic binding layer 16a is the center of two layers and sandwiched by layer 11 and layer 12.

Concord layer 14 is closed-cell high density polyethylene foam which has a thickness ranging from 1 to 5 mm and a density ranging from 4 to 10 lbs/ft³. This layer is to be bonded to the lower surface 23 of the reinforced core 13 by heat lamination. The reason being that the surface of the reinforced core 13 is made of polypropylene foam, a thermoplastic binding layer 16e is adopted to the outer surface 24 of the concord layer 14 for agglutination. The slick 15 is made of high density polyethylene and carries the form of a solid sheet. The solid sheet 15 has a thickness in the range of 0.1 to 1.5 mm. A process of heat-lamination is then used for bonding the concord layer 14 to the lower surface 23 of the reinforced core 13 and to the solid sheet 15 simultaneously. The rigidity of the board is enhanced with the ancillary of deck 12 and concord layer 14.

FIG. 2 shows a cross-sectional view of another structure of the invention. The structure of this gliding board consists of layer 23 acting as a core, a pair of stronger layers 22 and 24, top plastic film 21, a concord layer 25, and a slick (bottom solid sheet) 26. Similarly, the core may be closed-cell low density polyethylene foam or polystyrene having a thickness from 20 to 80 mm and a density ranging from 1.5 to 4 lbs/ft³. Similar to the embodiment in FIG. 1, core 23 is surrounded by stronger layers 22 and 24. The stronger layers are closed-cell high density crosslink or non-crosslink polypropylene foam having a thickness in the range of 1.5 to 5 mm and a density ranging from 4 to 9 lbs/ft³. A pair of thermoplastic binding layers 27a and 27b, respectively, are applied to the upper surface 29c and lower surface 29a of stronger layer 22. Similarly, another pair of thermoplastic binding layers 27c, 27d, respectively, are applied to the upper surface 29b and lower surface 29d of stronger layer 24. Thermoplastic binding layers 27b and 27c serve to bond the core 23 and stronger Layers 22 and 24. The thermoplastic substances applied in this embodiment are the same as illustrated in FIG. 1. A heat lamination method bonds layers 23, 22 and 24, and subsequently forming a reinforced core 28. A polyethylene plastic film 25 having graphic imprinted on the lower surface is adhered to the bottom surface 29d of the reinforced core 28. The plastic film layer 25 is closed-cell high density polyethylene foam having a thickness in the range of 0.02 to 0.15 mm. As mentioned above, a thermoplastic binding layer 27d is previously adhered to the lower surface 29d of the reinforced core 28. Thereafter, heat lamination processes bond the top plastic film 21 from the top and the slick 26 to form the gliding board. Slick 26 is high density polyethylene foam and top plastic film 21 is selected from polypropylene, PET and polyethylene foam in single or dual-layers. In this invention, graphics on both sides of the gliding board can be seen.

FIG. 3 shows a cross-sectional view of a third embodiment of the present invention of a gliding board. Similar to the embodiment in FIG. 2, the construction of this embodiment has a reinforced core 38 comparable to reinforced core 28. Conversely, with the exception of reinforced core 38, the foam layers in this arrangement consist largely of polypropylene material. A dual-layer top plastic film with printing represented by layer 31 consists of polypropylene and is adhered to the upper surface 39c of the reinforced core 38 by heat lamination without the aid of thermoplastic substance. Similarly, another plastic film layer 35 and a slick of polyethylene 36 are adhered to the bottom surface 39d of the reinforced core 38 also without the aid of thermoplastic substance by heat lamination simultaneously when bonding the top plastic film 31. Top plastic film 31 has a thickness ranging from 0.03 to 0.1 mm. The slick 36 has a thickness ranging from 0.1 to 1.5 mm.

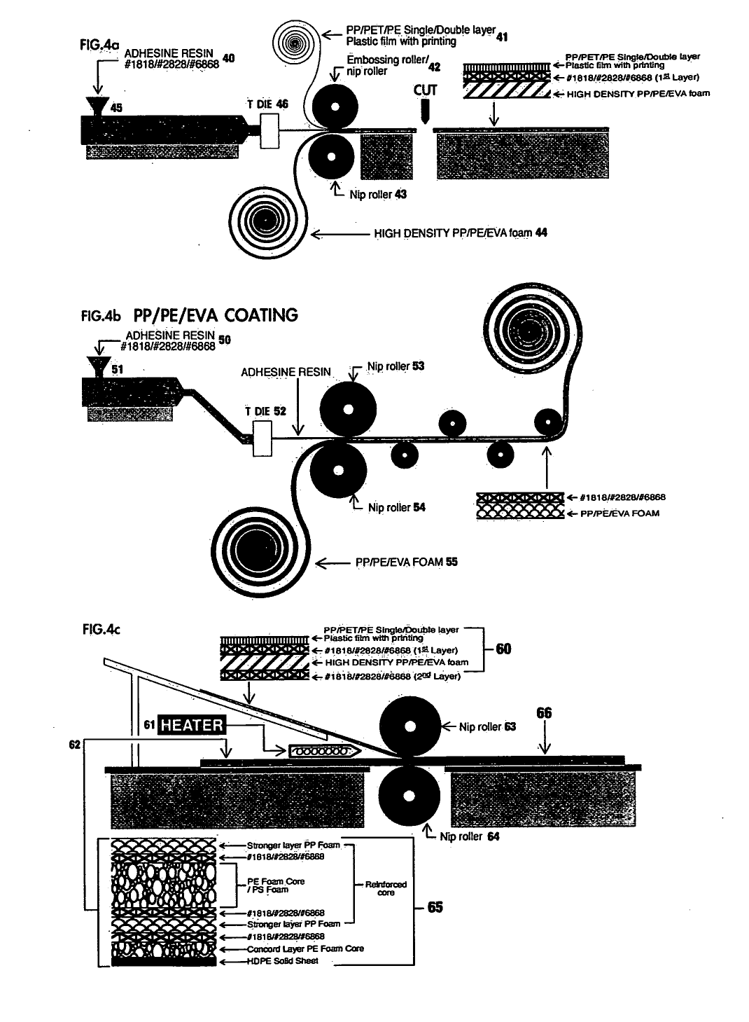

FIG. 4a illustrates a schematic view of the methodology of bonding top plastic graphic film 41 to a high density polypropylene or polyethylene or ethylene vinyl acetate deck 44 in the present invention. By shoving the compound thermoplastic substance #1818 which contains ethylene vinyl acetate copolymer and tackifying resin, or substance #2828 which contains metallocene-catalyzed resin and polyethylene; or substance #6868 which contains anhydride-modified ethylene vinyl acetate polymer into furnace 45 with a high temperature of 180 to 200 degrees, and thereafter passing through a T-die 46 for injection. A layer of compound thermoplastic substance is in between the plastic film 41 and deck 44 which are both in roll format and to be bonded and pressurized by the upper embossing or nip roller 42 and a lower nip roller 43 for reinforcement of the stiffness of the graphic film 41 to the deck 44.

FIG. 4b illustrates a schematic view of the new methodology of viscose of the board core layers of the invention. Similar to the procedure in FIG. 4a, by shoving the thermoplastic substances (#1818/ #2828/ #6868) 50 into the furnace 51 with a high temperature of 180 to 200 degrees, and thereafter passing through a T-die 52 for injection, a layer of thermoplastic substance 56 is on the surface of the polypropylene or polyethylene or ethylene vinyl acetate foam board 55 which is exported from a roll format and to be bonded and pressurized by the upper roller 53 and a lower roller 54 for reinforcement of the stiffness of the board. The same procedure will be repeated when the thermoplastic substance need to be coated on both sides of the foam layer.

FIG. 4c is a schematic view of the method of manufacturing a gliding board of the invention. By applying a heat lamination method through the febrifacient 61 and pushing through the pair of rollers 63, 64 for pressurizing, to bond the synthesizer of top plastic film and the deck 60 to the synthesizer of reinforced core, the concord layer and the high density solid sheet 65. Thereafter, behind the rollers 63, 64, the outer core 60 and board core 65 are pressed to have a curved shape at the front of the board, and the semi-product of the gliding board 66 will be processed afterwards by further heat lamination to extend the graphic film from top to the bottom of the solid sheet to form the gliding board.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents, including the composition by means of the number of layers, the densities of the foam materials and the thickness of each layers, may be resorted to, falling within the scope of the invention.

What is claimed is:

1. A laminated gliding board having a sandwich-like construction, based on a high density polyethylene foam core and adjacent composite polypropylene foam stronger layers comprising of:
a body having a top surface, a bottom surface, side surfaces and front and back surfaces;
a top plastic film with imprinted graphics;
a deck;
a three-ply reinforced core;
a concord layer; and
a slick.

2. The gliding board as claimed in claim 1, wherein said top plastic graphic film comprises of:
a top surface and a bottom surface;
said top surface is non-opaque;
said bottom surface having a graphic image reversely imprinted thereon;
a selected from polyethylene, polypropylene and PET having a thickness of approximately 0.02 to 0.15 mm; and
said bottom surface is bonded to the outer surface of said deck.

3. The gliding board as claimed in claim 1, wherein said top plastic graphic film, as an alternative, comprises of:
a dual-layer plastic film having an outer and an inner film;
a reverse graphic image imprinted on the inner surface of said outer film;
said outer film is adhered to said inner film by heat lamination as a whole forming said top plastic graphic film.

4. The gliding board as claimed in claim 3, wherein said top plastic graphic film further comprises of:
said outer film is non-opaque, having a top and a bottom surface, and having a reverse graphic image imprinted on said inner surface;
said inner film having an outer surface and an inner surface;
the inner surface of said outer film laminated to the outer surface of said inner film, and the inner surface of said inner film is bonded to the outer surface of said deck; and
said outer film has a thickness of approximately 0.02 to 0.15 mm and said inner film layer has a thickness of approximately 0.01 to 0.15 mm.

5. The gliding board as claimed in claim 1, wherein said deck comprises of:
an outer surface and an inner surface;
a select from polyethylene and ethylene vinyl acetate foam having a thickness in the range of 1 to 5 mm; and
a first thermoplastic binding layer having an outer surface and an inner surface, and having a thickness of approximately 0.02 to 0.10 mm.

6. The gliding board as claimed in claim 5, wherein said first thermoplastic binding layer is applied in manner of extrude coating to the outer surface of said deck, and said deck is bonded to said top plastic graphic film by heat lamination, wherein the inner surface of said top plastic film is affixed to the outer surface of said deck and the inner surface of said deck is to be affixed to the outer surface of said stronger layer above the core.

7. The gliding board as claimed in claim 5, wherein said first thermoplastic binding layer is selected from thermoplastic substance #1818 consisting of low density polyethylene, ethylene vinyl acetate and tackifying resin; thermoplastic substance #2828 consisting of metallocene-catalyzed resin and polyethylene; and thermoplastic substance #6868 consisting of anhydride-modified ethylene vinyl acetate polymers, having a thickness of approximately 0.02 to 0.10 mm.

8. The gliding board as claimed in claim 1, wherein said three-ply reinforced core comprises of:
a second thermoplastic binding layer having an outer surface and an inner surface and having a thickness of approximately 0.02 to 0.10 mm;
a closed-cell polypropylene foam stronger layer above the core having an outer and an inner surface and having a thickness in the range of 1.5 to 5 mm and a density ranging from 4 to 9 lbs/ft³;
a third thermoplastic binding layer having an outer and an inner surface and having a thickness of approximately 0.02 to 0.10 mm;
a close-cell low density polyethylene foam core having an outer and an inner surface and having a thickness ranging from 20 to 80 mm and a density in the range of 1.5 to 4 lbs/ft³;
a fourth thermoplastic binding layer having an outer and an inner surface and having a thickness of approximately 0.02 to 0.10 mm;
a closed-cell polypropylene foam stronger layer below the core having an outer and an inner surface and having a thickness in the range of 1.5 to 5 mm and a density ranging from 4 to 9 lbs/ft³; and
a fifth thermoplastic binding layer having an outer and an inner surface and having a thickness of approximately 0.02 to 0.10 mm.

9. The gliding board as claimed in claim 8, wherein said second and third thermoplastic binding layers, respectively, are applied in manner of extrude coating to the outer and inner surface of said stronger layer above the core; similarly, said fourth and fifth thermoplastic binding layers, respectively, are applied to the outer surface and inner surface of said stronger layers below the core in manner of extrude coating; thereafter, said stronger layer above the core, and said stronger below the core are laminated to said core, by heat lamination forming a three-ply reinforced core, wherein the inner surface of said stronger layer above the core having said third thermoplastic binding layer coated thereto is affixed to the outer surface of said core and the outer surface of said stronger layer below the core having said fourth thermoplastic binding layer coated thereto is affixed to the inner surface of said core.

10. The gliding board as claimed in claim 9, wherein said second, third and fourth thermoplastic binding layers are selected from thermoplastic substance #1818 consisting of low density polyethylene, ethylene vinyl acetate and tackifying resin; thermoplastic substance #2828 consisting of metallocene-catalyzed resin and polyethylene; and thermoplastic substance #6868 consisting of anhydride-modified ethylene vinyl acetate polymers, and each having a thickness of approximately 0.02 to 0.10 mm.

11. The gliding board as claimed in claim 1, wherein said concord layer comprises of:
a closed-cell polyethylene foam having an outer surface and an inner surface and having a thickness ranging from 1.5 to 5 mm and a density ranging from 4 to 10 lbs/ft³.

12. The gliding board as claimed in claim 11, wherein said concord layer is to be bonded to be bonded to said reinforced core by heat lamination, being that the upper surface of said concord layer is joined to the lower surface of said stronger layer below the core having said fifth thermoplastic binding layer affixed thereto.

13. The gliding board as claimed in claim 1, wherein said slick comprises of:
a high density polyethylene sheet having an outer and inner surface and having a thickness of approximately 0.1 to 1.5 mm.

14. The gliding board as claimed in claim 13, wherein the outer surface of said slick is bonded to the inner surface of said concord Layer by heat lamination.

15. A multi-layered gliding board comprising a top plastic film;
a three-ply reinforced core;
a lower plastic graphic film; and
a slick.

16. A multi-layered gliding board as claimed in claim 15, wherein said top plastic film comprises of:
a single or a dual-layer plastic film having an outer and an inner surface;
a reverse image imprinted on the bottom surface of said single plastic film, and said image being visible from outside of said top plastic film;
said single plastic film is non-opaque;
alternatively, a dual-layer plastic film having an outer and an inner film;
said outer film having a top and an inner surface;
said inner film having an outer and an inner surface;
a reverse image imprinted on the inner surface of said outer film, and said image being visible from outside of said outer plastic film;
said outer film is non-opaque;
said single or dual-layer plastic film is selected from polyethylene, polypropylene and PET foam having a thickness ranging from 0.02 to 0.15 mm.

17. A multi-layered gliding board as claimed in claim 16, wherein said inner surface of said top plastic film is affixed to the outer surface of said three-ply reinforced core if said top plastic film is a single layer; alternatively, the inner surface of said inner film is affixed to the outer surface of said three-ply reinforced core if said top plastic film is a dual-layer.

18. A multi-layered gliding board as claimed in claim 17, wherein said three-ply reinforced core comprises of:
a first thermoplastic binding layer having an outer and inner surface and having a thickness of approximately 0.02 to 0.10 mm;
a stronger layer above the core having an outer and inner surface and having a thickness ranging from 1.5 to 5 mm and a density ranging from 4 to 9 Lbs./ft.³;
said stronger layer above the core is crosslink or non-crosslink polypropylene foam;
a second thermoplastic binding layer having an outer and inner surface and having a thickness of approximately 0.02 to 0.10 mm;
a core having an outer and inner surface;
said core is a closed-cell low density polyethylene foam having a thickness ranging from 20 to 80 mm and a density ranging from 1.5 to 4 lbs/ft³;
a third thermoplastic binding layer having an outer and inner surface and having a thickness of approximately 0.02 to 0.10 mm;
a stronger layer below the core having an outer and inner surface;
said stronger layer below the core is crosslink or non-crosslink polypropylene foam having a thickness ranging from 1.5 to 5 mm and a density ranging from 4 to 9 lbs/ft³; and
a fourth thermoplastic binding layer having an outer and inner surface wherein the outer surface and having a thickness of approximately 0.02 to 0.10 mm.

19. A multi-layered gliding board as claimed in claim 18, wherein the lamination process of said three-ply reinforced core comprises of:
said first thermoplastic binding layer is affixed, using heat processes by way of extrude coating, to the outer surface of said stronger layer above the core;
similarly, said second thermoplastic binding layer is affixed to the inner surface of said stronger layer above the core;
using the same process, said third and fourth thermoplastic binding layers are affixed to the outer surface and inner surface of said stronger layer below the core respectively;
by heat lamination, said stronger layer above the core, said core and said stronger layer below the core are laminated together forming said reinforced core, in a such manner that the lower surface of said stronger layer above the core having said second thermoplastic binding layer affixed thereto is connected with the upper surface of said core whilst the upper surface of said stronger layer below the core having said third thermoplastic binding layer affixed thereto is joined with the lower surface of said core.

20. A multi-layered gliding board as claimed in claim 18, wherein said stronger layers consists of crosslink or non-crosslink polypropylene foam; said top plastic film is polypropylene foam; said thermoplastic binding layers are the cohesive agents for joining said plastic films, said stronger layers and said core.

21. A multi-layered gliding board as claimed in claim 20, wherein said first, second, third and fourth thermoplastic binding layers are selected from substance #1818 includes low density polyethylene, ethylene vinyl acetate and tackifying resin; substance #2828 includes metallocene-catalyzed resin and polyethylene; and substance #6868 includes anhydride-modified ethylene vinyl acetate polymers, and having a thickness of approximately 0.02 to 0.10 mm.

22. A multi-layered gliding board as claimed in claim 16, wherein said lower plastic film comprises of:
a single or a dual-layer plastic film having a top and bottom surface;
a reverse image imprinted on the bottom surface of said single plastic film, and said image being visible from outside of said plastic film;
said single plastic film is non-opaque;
alternatively, a dual-layer plastic film having an outer and inner film;
said outer film having a top and inner surface;
said inner film having an outer and inner surface;
a reverse image is imprinted on the inner surface of said outer film;
said outer film is non-opaque;
said single or dual-layer plastic film is selected from polyethylene, polypropylene and PET foam having a thickness ranging from 0.02 to 0.15 mm.

23. A multi-layered gliding board as claimed in claim 22, wherein the outer surface of said lower plastic film is adhered to the inner surface of said fourth thermoplastic binding layer if said top plastic film is single layer; alternatively, the outer surface of said outer film is bonded to the inner surface of said fourth thermoplastic binding layer if said lower plastic film is dual-layer.

24. A multi-layered gliding board as claimed in claim 16, wherein said slick comprises of:
a high density polypropylene sheet having a top surface and a bottom surface;
said polypropylene sheet having a thickness in the range of 0.1 to 1.5 mm; and
the top surface of said slick being heat bonded to the bottom surface of said lower plastic film.

25. A multi-layered gliding board as claimed in claim 25, wherein said slick, alternatively, is non-opaque and consists of a plastic film with printing that is heat bonded to the top surface.

26. The gliding board as claimed in claim 1, wherein said top surface plastic polymer graphic film extends in order to attach to the slick.
